(19) United States
(12) Patent Application Publication
(10) Pub. No.: US 2008/0297696 A1
(43) Pub. Date: Dec. 4, 2008

(54) LIGHT GUIDING PLATE UNIT, SURFACE LIGHT SOURCE APPARATUS AND LIQUID CRYSTAL DISPLAY APPARATUS

(75) Inventor: Saswatee BANERJEE, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY. LIMITED, Tokyo (JP)

(21) Appl. No.: 12/131,153

(22) Filed: Jun. 2, 2008

(30) Foreign Application Priority Data
Jun. 4, 2007 (JP) 2007-148469

(51) Int. Cl. F21V 7/04; G02F 1/1335

(52) U.S. Cl. 349/65; 362/617

(57) ABSTRACT

A light guiding plate unit which can emit uniform light of a predetermined polarization, a surface light source apparatus and a liquid crystal display apparatus are provided. A light guiding plate unit is provided with a light guiding plate which can guide light and has a first surface from which light is emitted and a diffraction grating which is provided on the first surface of the light guiding plate, and the diffraction grating is formed of a number of metal wires in straight lines which are aligned in a direction approximately perpendicular to the long axis of the metal wires, and the length w of the metal wires in the direction in which the number of metal wires are aligned is approximately 55% or more and approximately 85% or less of the spatial period of the diffraction grating. Thus, the ratio of the length w of the metal wires to the spatial period is set to 0.65 or higher and 0.85 or lower, and thus, it is possible to control the amount of transmission of light in a predetermined state of polarization through the diffraction grating formed on the first surface.

### BACKGROUND OF THE INVENTION

1. Field of the Invention

The present invention relates to a light guiding plate unit, a surface light source apparatus and a liquid crystal display apparatus.

2. Description of the Related Art

A liquid crystal display (LCD) device typically includes a liquid crystal display apparatus. The liquid crystal display apparatus has a liquid crystal display unit and a surface source apparatus placed on the rear surface side (bottom side) of the liquid crystal display unit. The liquid crystal display unit comprises of a liquid crystal display panel and a pair of polarizing plates placed on the top and bottom surfaces of the liquid crystal display panel respectively.

The above mentioned surface source apparatus typically has a ‘backlight’ unit. The backlight unit can either be edge-lit type or back-lit type. Edge-lit type surface source apparatuses are commonly used in liquid crystal display apparatuses used in mobile phones, and laptop personal computers, so as to reduce the thickness and increase the compactness of the device.

An edge-lit type surface light source apparatus includes a light guiding plate and a light source unit placed on one of the side faces of the light guiding plate. The above mentioned side face through which light from the light source unit enters the light guiding plate will henceforth be called the input surface. Light guiding plate is a slab of transparent material through which light propagates from the input surface to the other end. Most of the light that enters the light guiding plate from the source making large incidence angles with the normal to the input surface escapes the light guiding plate through its top and bottom surfaces. In contrast, the light that enters the light guiding plate paraxially i.e., incidence angles smaller than certain critical value is guided along the length of the light guiding plate. The mechanism responsible for guidance of light through the light guiding plate is called total reflection. The amount of light escaping the light guiding plate through its top surface is used to illuminate the liquid crystal display unit. The light output of the light guiding plate is determined by the critical angle of total reflection, which is decided by the refractive indices of the light guiding plate and the surrounding medium.

For the above described surface light source apparatus to be included in a liquid crystal display apparatus it is necessary that the emitted light flux be distributed homogeneously over the output surf ace of the light guiding plate. In conventional backlight units uniformity of light output is ensured by employing diffusing plates or prism sheets that collect and spread the output light in a prespecified angular range suitable for illumination of liquid crystal display units.

Moreover, in conventional liquid crystal display apparatuses, the output of the surface light source apparatus is in general not polarized. The output from the surface light source is made to pass through a polarizing plate placed on the bottom surface of the liquid crystal display panel. The output of the polarizing plate is linearly polarized along one specified direction. Light associated with the unused, orthogonal polarization component is absorbed inside the polarizing plate, reducing the light utilization efficiency.

Wire grid polarizers consisting of a number of metal fine wires aligned in parallel straight lines with constant, predetermined intervals in between and mounted on the output surface of a light guiding plate, has been proposed, for example, in a US examined Patent (Publication No. 2007/0047214), as a method to realize compact polarizing backlights. The wire grid is a light polarizer that allows light in one polarization state to be transmitted while reflecting the light in orthogonal polarization state, as described in, for example, Xiang-Dong Mi, David Kessler, Lee W. Tutt and Lura Weller-Brophy, “Low Fill-Factor Wire Grid Polarizers for LCD Backlighting,” SID Digest, pp. 1004-1007, 2005.

A wire grid polarizer divides the incident unpolarized light into two, separated, orthogonally polarized light components. Since the absorption is minimal and the reflected component can be recycled, light utilization efficiency increases. The reflected component is recycled by passing it through a polarization converter and directing it toward the output surface of the light guiding plate at an angle lesser than the above mentioned critical angle.

However, conventional wire grid type light polarizers are designed to increase the degree of polarization by maximizing the transmitted component and minimizing the reflected component. Hence light guiding plates equipped with conventional wire grid polarizers on output surface can not guarantee uniformity of emitted flux over the entire output surface. This is because, as the light propagates through the light guiding plate the total light output goes on diminishing. Consequently, the output falls off as the distance of the emission point from the source increases.

Accordingly, an objective of the present invention is to provide a liquid crystal display apparatus that incorporates a surface light source apparatus which in turn includes a light guiding plate unit and is capable of emitting uniform light linearly polarized in a predetermined direction.

### SUMMARY OF THE INVENTION

The light guiding plate unit according to the present invention is provided with: a light guiding plate that can guide light and has a first surface through which light is emitted; and a diffraction grating provided on the first surface of the light guiding plate. The diffraction grating is formed by laying out a number of straight metal wires parallel to each other. The length of the metal wires in the direction perpendicular to the long axis of the metal wires and parallel to the first surface is approximately 55% or more and approximately 85% or less of the spatial period of the diffraction grating.

In addition, the surface light source apparatus according to the present invention is provided with: a light guiding plate which can guide light and has a first surface through which light is emitted; a light source for outputting light which is guided through the light guiding plate; and a diffraction grating provided on the first surface of the light guiding plate, characterized in that the diffraction grating is formed of a number of metal wires which are laid out in parallel straight lines, and the length of the metal wires in the direction perpendicular to the long axis of the metal wires and parallel to the first surface is approximately 55% or more and approximately 85% or less of the spatial period of the diffraction grating.

Furthermore, the liquid crystal display apparatus according to the present invention is provided with: a surface light source apparatus; and a liquid crystal display unit into which light emitted from the surface light source apparatus enters, wherein the surface light source apparatus is provided with: a light guiding plate which can guide light and has a first surface through which light is emitted; a light source unit for outputting light; and a diffraction grating provided on the first surface of the light guiding plate, characterized in that the diffraction grating is formed of a number of metal wires which are laid out in parallel straight lines, and the length of the metal wires in the direction perpendicular to the long axis of the metal wires and parallel to the first surface is approximately 55% or more and approximately 85% or less of the spatial period of the diffraction grating.

In the configuration of the light guiding plate unit, the surface light source apparatus and the liquid crystal display apparatus according to the present invention, a diffraction grating is provided on the first surface of the light guiding plate, and this diffraction grating is formed of a number of metal wires laid out in parallel straight lines, that is to say, formed so as to be positioned in a direction approximately perpendicular to the long axis of the metal wires. The diffraction grating having this configuration functions as a polarizer and separator of light by transmitting light linearly polarized in a predetermined direction while reflecting the light component polarized in the orthogonal plane. In the above described configuration, light that is guided through the light guiding plate and reaches the first surface or light that emits through the first surf ace is incident on the diffraction grating so that a predetermined polarized light component is transmitted through the diffraction grating, while the other part is reflected from the diffraction grating back into the light guiding plate.

In the case where the fill factor of the diffraction grating (ratio of length of metal wires in a direction perpendicular to long axis of metal wires and parallel to the first surface (length of metal wires in a direction in which number of metal wires are aligned) to spatial period of diffraction grating) is set so that the transmissivity of one polarized light component (for example P-polarized light) becomes maximum, most of the polarized light component is emitted through the region of the output surface closest to the source.

In contrast, in the light guiding plate unit, the surface light source apparatus and the liquid crystal display apparatus according to the present invention, the fill factor of the diffraction grating provided on the first surface is 0.55 or greater and 0.85 or smaller, and the transmissivity of the diffraction grating for a predetermined polarized light component (for example P-polarized light) is kept low. As a result, a larger portion of the input light returns back to the light guiding plate in comparison with the conventional case described above where the design objective is to maximize the light flux associated with the transmitted component in a predetermined state of polarization. Accordingly, the proportion of input light that can be recycled becomes larger in the proposed invention. Therefore, flux of emitted light polarized in a predetermined state is spread homogeneously over the entire output surface of the light guiding plate unit. It is not necessary to provide a new light polarizing element for reusing the non-transmitted polarized component in the liquid crystal display apparatus which includes the above described light guiding plate unit or surface light source apparatus, and therefore, reduction in the thickness of the liquid crystal display apparatus can be achieved. In addition, since the liquid crystal display unit in the liquid crystal display apparatus can be uniformly illuminated, image unevenness can be prevented.

Herein, in the case where a diffraction grating is provided on the first surface as described above, the diffraction grating may be provided directly on the first surface, the diffraction grating may be provided on top of one or multiple dielectric layers having light transmitting properties and is formed on the first surface, or the diffraction grating may be provided as a separate, stand-alone element that is placed at a distance from the first surface.

According to the present invention, it is preferable that the length of the metal wires in the direction perpendicular to the long axis of the above mentioned metal wires and parallel to the first surface to be approximately 65% or more and approximately 85% or less of the above mentioned spatial period of the arrangement of the above mentioned metal wires in the light guiding plate unit. In addition, it is preferable for the length of the metal wires in the direction perpendicular to the long axis of the above mentioned metal wires and parallel to the first surface to be approximately 65% or more and approximately 85% or less of the above described spatial period in the surface light source apparatus according to the present invention. Likewise, it is preferable for the length of the metal wires in the direction perpendicular to the long axis of the above described metal wires and parallel to the first surface to be approximately 65% or more and approximately 85% or less of the above described spatial period in the liquid crystal display apparatus according to the present invention.

It is preferable for a reflecting and diffusing unit to further be provided on the second surface of the light guiding plate, which faces the first surface, where the reflecting and diffusing unit depolarizes light that propagates toward the second surface and reflects the unpolarized light toward the first surface in the light guiding plate unit according to the present invention. Likewise, it is preferable for a reflecting and diffusing unit to further be provided on the second surface of the light guiding plate, which faces the first surface, where the reflecting and diffusing unit is located on the second surface side, depolarizes light that propagates toward the second surface side and reflects the unpolarized light toward the light guiding plate side in the surface light source apparatus according to the present invention. In the same way, it is preferable for a reflecting and diffusing unit to further be provided on the light guiding plate, where the light guiding plate has a second surface which faces the first surface and the reflecting and diffusing unit is located on the second surface side, depolarizes light that propagates toward the second surface side and reflects the unpolarized light toward the light guiding plate side in the liquid crystal display apparatus according to the present invention.

Light that propagates toward the second surface includes light that is reflected from the diffraction grating toward the light guiding plate side, and contains more light in a polarization state that differs from that of the transmitted component. In the above described configuration consisting of a reflecting and diffusing unit, light that propagates toward the second surface and reaches the reflecting unit is depolarized by the reflecting unit and reflected back toward the first surface of the light guiding plate. Therefore, unpolarized light is incident on the diffraction grating. As a result, it is possible for the surface source apparatus to emit light polarized in a predetermined state uniformly.

In addition, it is preferable for the surface light source apparatus according to the present invention to further be provided with a reflecting member which is placed on the outside of the light source and reflects light emitted from the light source toward the light guiding plate side. Likewise, it is preferable for the liquid crystal display apparatus according to the present invention to further be provided with a reflecting member which is placed on the outside of the light source and reflects light emitted from the light source toward the light guiding plate side. Thus, when a reflecting member is further provided, light emitted from the light source enters into the light guiding plate in an appropriate manner. As a result, the utilization efficiency of light emitted from the light source can be increased.

In addition, in the case where the above described diffraction grating is integrated directly onto the first surface, it is preferable for the spatial period to be approximately 57% or less of the wavelength of light. In this case, the index of refraction of the light guiding plate is taken to be approximately 1.49. In addition, in the case where the above described diffraction grating is located at a distance from the first surface and the medium surrounding the diffraction grating is air, it is preferable for the above described spatial period to be approximately 40% or less of the wavelength of light. The upper limit for the above described spatial period is set so as to make the diffraction grating function as a zero-order diffraction grating for generating mainly zero-order non-diffracted light, by preventing higher order diffracted light from being generated, and when the above described spatial period is employed, the diffraction grating functions as a zero-order grating.

In addition, in the case where the above described diffraction grating is integrated directly on the first surface and the index of refraction of the light guiding plate is approximately 1.49, the spatial period can be set to 271 nm or less for blue light (for example, wavelength of light is approximately 475 nm), and the spatial period can be set to 364.8 nm or less for red light (for example, wavelength of light is approximately 640 nm). In addition, in the case where the above described diffraction grating is located at a distance from the first surface and the medium surrounding the diffraction grating is air, the spatial period can be set to approximately 190 nm or less for blue light (for example, wavelength of light is approximately 475 nm), and the spatial period can be set to approximately 256 nm or less for red light (for example, wavelength of light is approximately 640 nm).

In addition, it is preferable for the transmittance of the diffraction grating to be approximately 7% or higher and approximately 30% or lower in the case where light having a wavelength of longer than 500 nm enters into the above described diffraction grating. As a result, transmissivities for green light (for example, wavelength of light is approximately 575 nm) and for red light (for example, wavelength of light is approximately 640 nm), for example, should be in the above described range.

In addition, it is preferable for the transmissivity of the diffraction grating to be approximately 7% or higher and approximately 35% or lower in the case where light having a wavelength of 500 nm or shorter enters into the diffraction grating. As a result, transmissivity of blue light (for example, wavelength of light is approximately 475 nm), for example, should be in the above described range.

Furthermore, it is preferable for the length of the metal wires in a direction normal to the plane containing the above-described diffraction grating to be approximately 400 nm or less. When the length of the metal wires in the direction of the normal of the diffraction grating plane is in the above-described range, it becomes possible to use light effectively.

In addition, it is preferable for a cross-sectional shape of the metal wires that are approximately perpendicular to the longitudinal direction of the metal wires to be square or rectangular. In the case where the metal wires have such a cross-sectional shape, it becomes easy to control the above described fill factor, and at the same time, loss of light through absorption can be reduced.

In addition, it is preferable for the degree of polarization of light transmitted through the above described diffraction grating to be approximately 70% or higher. In this case, light emitted from the light guiding plate unit can be used in an appropriate manner, for example as a backlight for the liquid crystal display panel of the liquid crystal display apparatus.

In addition, it is preferable for the brightness of the light transmitted through the diffraction grating to be approximately uniform within an angular range of approximately 0° or higher and approximately 30° or lower relative to the direction of the normal to the plane containing the diffraction grating. In this case, unevenness in the brightness can be reduced when light emitted from the light guiding plate unit is used as light for illumination, for example as a backlight for a liquid crystal display panel in a liquid crystal display apparatus.

In addition, it is preferable for the above-described light guiding plate to have a second surface that faces the first surface and a third surface that is positioned on one side of the first and second surfaces in such a manner that the third surface is inclined relative to one or either of the first and second surfaces. It is possible to adjust the angle of inclination of the third surface so as to channelize most of the input light into a desired direction so that this light is incident on the diffraction grating at certain predetermined angles. When light is incident on the diffraction grating making a large angle with the normal to the grating plane, loss of light due to the skin depth of metal becomes unacceptably large. Aforementioned metallic loss is reduced increasing the light utilization efficiency as long as light is incident on the diffraction grating at small angles. In the surface light source apparatus according to the present invention, a light source is placed so as to face the third surface, and in the case where light emitted from the light source enters the light guiding plate through the third surface, the third surface is inclined relative to the second surface, and the angle of inclination can be set as to be greater than approximately 0° and approximately 30° or less. In addition, the light source is placed so as to face the second surface in the surface light source apparatus according to the present invention, and in the case where light emitted from the light source enters into the light guiding plate through the second surface, it is preferable for the third surface to be inclined relative to the second surface.

The light guiding plate unit and the surface light source apparatus that incorporates such a light guiding plate unit as described in the present invention can emit light in a predetermined state of polarization uniformly over the output surface. Furthermore, the liquid crystal display apparatus according to the present invention makes it possible for light in a predetermined state of polarization to be emitted from the surface light source apparatus of the liquid crystal display apparatus uniformly, and thus, makes it possible to prevent image unevenness.

### BRIEF DESCRIPTION OF THE DRAWINGS

FIG. 1 is a side view showing the surface light source apparatus according to one embodiment of the present invention;

FIG. 2 is a side view showing the liquid crystal display apparatus according to one embodiment of the present invention;

FIG. 3 is a cross-sectional view showing the surface light source apparatus according to another embodiment of the present invention;

FIG. 4 is a cross-sectional view showing the surface light source apparatus according to still another embodiment of the present invention;

FIGS. 5A and 5B are graphs showing the results of simulation in the case of the conditions 1 and 2;

FIGS. 6A and 6B are graphs showing the results of simulation in the case of the conditions 3 and 4;

FIGS. 7A and 7B are graphs showing the results of simulation in the case of the conditions 5 and 6;

FIG. 8 is a graph showing the results of simulation in the case of the conditions 7 to 9;

FIG. 9 is a graph showing the results of simulation in the case of the condition 10; and

FIG. 10 is a side view showing the surface light source apparatus according to yet another embodiment of the present invention.

### DETAILED DESCRIPTION OF THE PREFERRED EMBODIMENTS

In the following, the light guiding plate unit, the surface light source apparatus and the liquid crystal display apparatus according to embodiments of the present invention are described in reference to the drawings. Herein, the same symbols are attached to the components that are same as in the description of the drawings, and the same descriptions are not repeated. In addition, the proportions in the drawings do not necessarily correspond to those mentioned in the description.

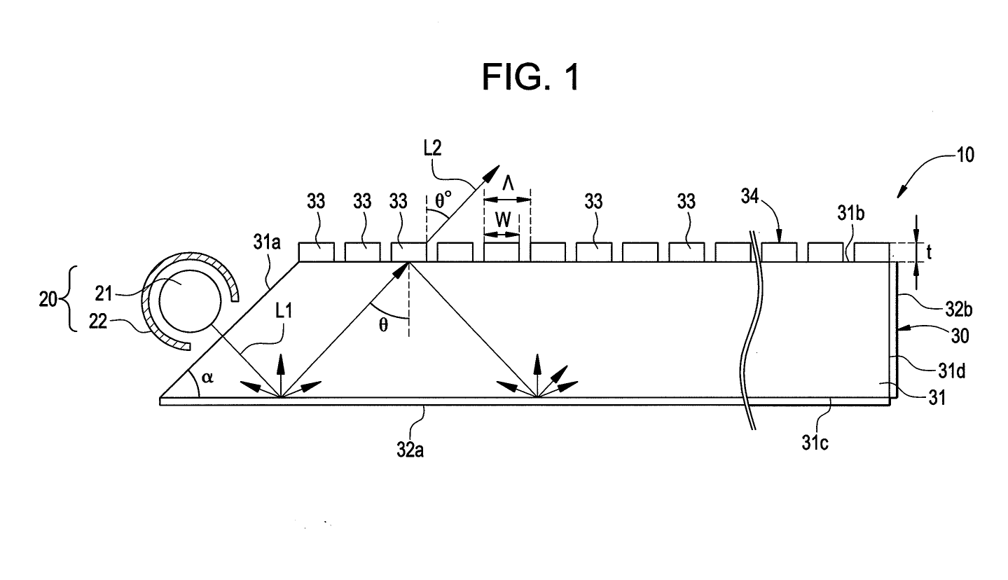

FIG. 1 is a schematic side view showing the configuration of the surface light source apparatus according to one embodiment of the present invention. The surface light source apparatus 10 is an edge-lit type apparatus consisting of a light source unit 20 and a light guiding plate unit 30, and the light source unit 20 is located on one side of the light guiding plate unit 30. The surface light source apparatus 10 is appropriate for use as a backlight for liquid crystal display apparatuses, particularly liquid crystal display apparatuses used in mobile phones and laptop personal computers.

The light source unit 20 has a light source 21 for emitting light L1 which represents visible light and a reflecting member 22 which is provided outside the light source 21. FIG. 1 shows the cross-sectional shape of the reflecting member 22, for the sake of convenience in description. In addition, light is schematically shown using solid arrows, and this way of showing light is the same in other figures. Though a fluorescent light in the shape of a rod is illustrated as the light source 21, there are no particular limitations on the shape of the light source, as long as light L1 which represents visible light of wavelength 400 nm or more and 700 nm or less is emitted, and it is possible to use light emitting diodes, for example. Herein, the light source 21 is described as a fluorescent light.

The reflecting member 22 is formed by bending a reflecting sheet in the shape of a cylinder, the inner surface of which is a mirror so as to reflect white light. The reflecting member 22 is placed so that it surrounds the light source 21 and has an opening on the side facing the light guiding plate 30. In the configuration of the light source unit 20, light L1 emitted from the light source 21 is reflected from the reflecting member 22 so as to be emitted through the opening and to be incident on the side of the light guiding plate 30.

The light guiding plate unit 30 has a light guiding plate 31 which transmits and distributes light over a wide surface in the form of a wedge or a parallel plate made of a colorless, transparent resin so as to be able to guide light. Acryl, polystyrene and polycarbonate based resins can be cited as examples of the colorless, transparent resin. Herein, the light guiding plate 31 is described as being made of PMMA, which is an acrylic resin.

The light guiding plate 31 is a slab with an approximate rectangular, parallelepiped or trapezoidal cross section and has a side (third surface) 31a which faces the light source unit 20. Light L1 from the light source unit 20 enters the light guiding plate through the third surface 31a. The light guiding plate 31 consists also of an emission or output surface (first surface) 31b which meets the input surface 31a at one end of side 31a. a rear surface (second surface) 31c which faces the emission surface 31b and meets the input surface 31a at the other end of side 31a, and a side 31d which faces the input surface 31a and is approximately perpendicular to the emission surface 31b and the rear surface 31c. It is possible for the light guiding plate 31 to be in wedge shape, for example, in addition to rectangular parallelepiped form. In the following, the side where the emission surface 31b is located relative to the rear surface 31c is referred to as the “upward” direction in the description, as a matter of convention. In the following descriptions the side 31a through which light L1 enters is also referred to as input surface 31a.

The input surface 31a, the emission surface 31b, the rear surface 31c and the side 31d are all flat. As shown in FIG. 1, the emission surface 31b and the rear surface 31c are approximately parallel, and the input surface 31a is inclined relative to the rear surface 31c. The angle of inclination a between the input surface 31a and the rear surface 31c is set to be greater than approximately 0° and approximately 30° or less, and approximately 20° can be cited as one example. A diffusing and reflecting film (reflecting unit) 32a for reflecting light L1 that enters through the entrance surface 31a to the emission surface 31b side while diffusing it is formed on almost the entire surface of the rear surface 31c. A coating of diffusing paint can be cited as an example of the diffusing and reflecting film 32a. Herein, though the diffusing and reflecting film 32a is illustrated as the reflecting unit provided on the rear surface 31c, there are no particular limitations as long as light L1 that propagates to the rear surface 31c side is reflected while being diffused and depolarized, and microscopic structures, such as trenches and/or protrusions, may be created on the rear surface 31c. In addition, as shown in FIG. 1, the diffusing and reflecting film 32b can be formed on the side 31d as the reflecting unit.

A metal grating (diffraction grating) 34 where a number of metal fine wires 33 in straight lines are aligned at approximately equal intervals in a direction approximately perpendicular to the longitudinal direction of the metal fine wires (metal strips) 33 is provided on the emission surface 31b. The direction of the normal to the metal grating 34 coincides with the direction of the normal to the emission surface 31b. A rectangle or a square can be cited as an example of the cross-sectional shape of the metal fine wires 33, which is approximately perpendicular to the longitudinal direction of the metal fine wires 33. When the shape of the cross-section is a rectangle or a square, it becomes easy to control the fill factor described below, and at the same time, loss of light due to absorption can be reduced. Though the choice of metal for fine wires 33 is not particularly restricted, preferred choice is either aluminum or silver, for example. This is because there is little absorption in the wavelength range of visible light. In addition, aluminum is more preferable from a point of view of cost effectiveness.

The metal grating 34 is a polarization separating unit which selectively transmits the P-polarized light in a plane approximately perpendicular to the longitudinal direction of the metal fine wires 33, in the same manner as so-called wire grids, and at the same time, reflects the S-polarized light. In the present embodiment, TM mode corresponds to the P-polarized component and TE mode corresponds to the S-polarized component, and therefore, in the following, TM mode and TE mode are referred to as P-polarized component and S-polarized component in the description.

The fill factor of the metal grating 34 is 0.55 or higher and 0.85 or lower, preferably 0.65 or higher and 0.85 or lower. The fill factor is defined as the ratio of the width w of the metal fine wires 33 (length of metal fine wires 33 in a direction in which metal fine wires 33 are aligned) to the spatial period Λ of the metal grating 34, that is to say, w/Λ. The spatial period Λ of the metal fine wires 33, the width w of the metal fine wires 33 and the thickness t of the metal fine wires 33 determine the amount of light L1 that is extracted via the metal grating 34 when the fill factor becomes 0.55 or higher and 0.85 or lower, preferably 0.65 or higher and 0.85 or lower.

The upper limit for the spatial period Λ of the metal grating 34 depends on the index of refraction and the incidence angle of the light guiding plate 31. The upper limit for the spatial period Λ is set so that the metal grating 34 functions as a diffraction grating of the 0 order which generates little or no diffracted light of a higher order, irrespective of the incidence angle, and mainly transmits light in the specular order. As shown in FIG. 1, it is preferable for the spatial period Λ to be 57% or less of the wavelength λ of light L1 in the case where the metal grating 34 is integrated directly on the emission surface 31b and the index of refraction of the light guiding plate 31 is approximately 1.490, for example. The index of refraction of the light guiding plate 31 is taken to be constant over the entire wavelength range of visible light. In addition, the lower limit for the spatial period Λ is determined on the basis of the microscopic processing technology for fabricating the metal grating 34 and is approximately 65 nm, for example. The width w of the metal fine wires 33 is chosen in keeping with the spatial period Λ, for example, so that the fill factor becomes 0.55 or higher and 0.85 or lower, preferably 0.65 of higher and 0.85 or lower.

In addition, it is preferable that the thickness t of the metal fine wires 33 is set to be 400 nm or less, so that absorption of the P-polarized component by the metal fine wires 33 is reduced. In the case where the wavelength of light L1 is 527 nm, for example, absorption of the P-polarized component by the metal fine wires 33 tends to be greater than 15% and the light utilization efficiency of L1 decreases when the thickness t is greater than 400 nm. Accordingly, it is preferable that the thickness t to be 400 nm or less. The lower limit for the thickness t can be determined so that a predetermined amount of the P-polarized component can be gained from light L1, and at the same time, the S-polarized component can be reflected, and is approximately 30 nm, for example. This is because when the thickness t is less than 30 nm, there is a risk that light L1 may transmit, as in the case where there is almost no metal grating 34, and there may be cases where the transmittance of the S-polarized component increases.

A microscopic processing technology, such as lithographic technique can be cited as an example of an appropriate manufacturing method for the metal grating 34. For example, a metal thin film having a desired thickness t made of the same material as the metal fine wires 33 may be formed on the emission surface 31b, and after that, this metal thin film may be processed to a diffraction grating having a desired spatial period Λ and width w using the lithographic technique, and thus, the metal grating 34 may be realized. In addition, it is also possible to fabricate the metal grating 34 by carrying out nanoimprinting using a paste in which metal fine particles are dispersed, for example.

In the light guiding plate unit 30, it is important for the fill factor of the metal grating 34 to have a value of 0.55 or higher and 0.85 or lower.

The fill factor of conventional wire grids is selected so that the transmittance of one polarized component becomes maximum. When conventional wire grids are placed in air, the fill factor value is chosen within a range from 0.4 to 0.6. Conventional wire grids have been developed with smaller fill factor, in order to maximize the amount of transmission of the arized component and minimize the amount of reflection of the S-polarized component, and Non-Patent Document 1, for example, states that a fill factor having a value within a range from 0.18 to 0.25 is achieved.

In contrast, the present inventor focused on controlling the amount of transmission of one polarized component by adjusting the fill factor, unlike conventional trends in the development of wire grids, where the transmission of one polarized component is maximized by making the fill factor smaller. In addition, the present inventor found that the amount of transmission of the P-polarized component can be controlled by adjusting the fill factor, and furthermore, found that a predetermined amount of light L1 can be extracted from the light guiding plate 31 while light L1 effectively propagates through the light guiding plate 31 by setting the fill factor to a value within the above described predetermined range of 0.55 or higher and 0.85 or lower, preferably 0.65 or higher and 0.85 or lower. In addition, in the configuration of the light guiding plate unit 30, the fill factor of the metal grating 34 has a value within the above described predetermined range, and therefore, the amount of transmission of the P-polarized component of light L1 which enters light guiding plate 31 can be controlled, and it becomes possible to allow a part of the p polarized component from the input light to transmit while reflecting the other component.

The working principles of the light guiding plate unit 30 and the surface light source apparatus 10 in which it is included are described below.

Light L1 having emitted from the light source 21 through the opening in the reflecting member 22, enters the light guiding plate 31 via the input surface. Light L1 that enters the light guiding plate in this manner gets reflected from the diffusing and reflecting film 32a provided on the rear surface 31c toward the emission surface 31b side. The light L1 that is reflected from the diffusing and reflecting film 32a toward the emission surface 31b side becomes unpolarized, and consists of approximately 50% of each of S and P-polarized components.

The metal grating 34 is formed on the emission surface 31b, and the metal grating 34 transmits a predetermined amount of the P-polarized light and reflects the rest, and therefore, part of light L1 that impinges on the metal grating 34 is transmitted and the rest is reflected toward the rear surface 31c side. In addition, the diffusing and reflecting film 32a is formed on the rear surface 31c, and therefore, light L1 propagates through the light guiding plate 31 while being repeatedly reflected between the emission surface 31b and the rear surface 31c.

The metal grating 34 has the above described transmitting and reflecting properties, and therefore, the S-polarized component tends to be dominant in the light L1 that is reflected and directed toward the side of the rear surface 31c. However, the light L1 is reflected from the diffusing and reflecting film 32a on the rear surface 31c side while being diffused, and therefore, light L1 that is reflected toward the side of the emission surface 31b becomes unpolarized light. As a result, light L1 in an unpolarized state impinges on the emission surface 31b. Accordingly, light of the P-polarized component is emitted from approximately the entire area of the emission surface 31b. In the following, the light that is transmitted through the emission surface 31b to the surrounding medium is referred to as light L2.

In case of conventional wire grid type polarizer design where the fill factor of the metal grating formed on the light guiding plate 31 is kept small, the metal grating tramits more of the P-polarized component of light L1. Therefore, light is mainly emitted from the portion of emission surface 31b which is closer to the input surface 31a. As a result, less light propagates through the light guiding plate 31, and as a result, light emission tends to be non-homogeneous over the entire emission surface 31b.

In contrast, if the fill factor of the metal grating 34 has a value of 0.55 or higher and 0.85 or lower, preferably 0.65 or higher and 0.85 or lower in the light guiding plate unit 30 shown in FIG. 1, then the amount of emitted light L1 can be controlled. As a result, light L1 can propagate through the light guiding plate 31 while part of light L1 is emitted from the emission surface 31b. Furthermore, as shown in the results of simulation described below, the metal grating 34 selectively reflects the S-polarized component, and at the same time, a portion of P-polarized component that does not transmit is reflected too. In addition, the reflected light L1 is again converted to light L1 in an unpolarized state by the diffusing and reflecting film 32a, and then the reflected light impinges on the metal grating 34 provided on the emission surface 31b. Therefore, light L1 that is separated by the metal grating 34 and returns into the light guiding plate 31 can be effectively reused in the configuration of the light guiding plate unit 30. In addition, as shown in FIG. 1, in the case where the diffusing and reflecting film 32b is provided on the side 31d, light that propagates to the side 31d can be converted to unpolarized light and be returned toward the input surface 31a side, and therefore, it is possible to use the light L1 more effectively.

In order for uniform light L2 where the P-polarized component is dominant to be emitted from approximately the entirety of the emission surface 31b, it is preferable for the metal grating 34 to be formed in such a manner that the transmittance T_{P} of the P-polarized component is approximately 7% to approximately 35% when the angle θ at which light L1 enters the metal grating 34 (see FIG. 1) is approximately 0° to approximately 30° in the case where light L1 enters the metal grating 34 once. The transmissivity T_{P}=100×I2_{P}/I1 when the intensity of light L1 that enters the metal grating 34 is I1 and the intensity of the P-polarized component of light L2 that is emitted from the metal grating 34 is I2_{P}. In this case, the transmissivity T_{P} at any given location on the emission surface 31b is approximately 7% to approximately 35%. In addition, when the transmissivity T_{P} is approximately 7% or higher and is approximately 35% or lower, light L2 is appropriate for use as illumination light (backlight) in liquid crystal display apparatuses, for example. Herein, it is preferable for the transmissivity T_{P} to be approximately 7% to approximately 30% for light having awavelength of greater than 500 nm (for example, from green to red light), and for it to be approximately 7% to approximately 35% for light having a wavelength of 500 nm or shorter (for example, blue light) when the incidence angle θ is in the above described range.

In addition, it is preferable for the metal grating 34 to be formed so that the transmissivity T_{S} of the S-polarized component is approximately 0% to approximately 5% when the incidence angle θ is approximately 0° or higher and approximately 30° or lower. The transmissivity T_{S}=100×I2_{S}/I1 when the intensity of the S-polarized component of light L2 emitted from the metal grating 34 is I2_{S}. In this case, the transmissivity T_{S} at any given location on the emission surface 31b is approximately 0% to approximately 5%. Light that enters the metal grating 34 and is not emitted as light L2 returns to the side of the light guiding plate 31, as described above. In addition, the diffusing and reflecting film 32a is provided on the rear surface 31b of the light guiding plate 31 so that light that propagates to the rear surface 31c side is reflected in an unpolarized state. Accordingly, in the case where the transmissivity T_{S} of the S-polarized component is in the above described range, a greater amount of the S-polarized component returns into the light guiding plate 31 so as to be depolarized, and the unpolarized light enters the metal grating 34 again. Accordingly, it is possible to effectively reuse the S-polarized component otherwise, light in this polarization component would unnecessarily be wasted. Accordingly, when transmissivity T_{S} of the S-polarized component is in the above described range, a high degree of polarization (for example, greater than 70%) can be attained in the transmitted light.

Furthermore, it is preferable that the metal grating 34 be formed so that the maximum value of the reflectivity R at each point of the emission surface 31b is approximately 80% or higher and 90% or lower of the incident light flux when light is incident normally onto the metal grating 34. The reflectivity R=100×(I3_{P}+I3_{S})I1 when the intensity of the P-polarized component of light that returns to the light guiding plate 31 side in the metal grating 34 is I3_{P} and the intensity of the S-polarized component is I3_{S}. When the maximum value of the reflectivity R is in the above described range, light loss becomes minimum and light utilization efficiency becomes high.

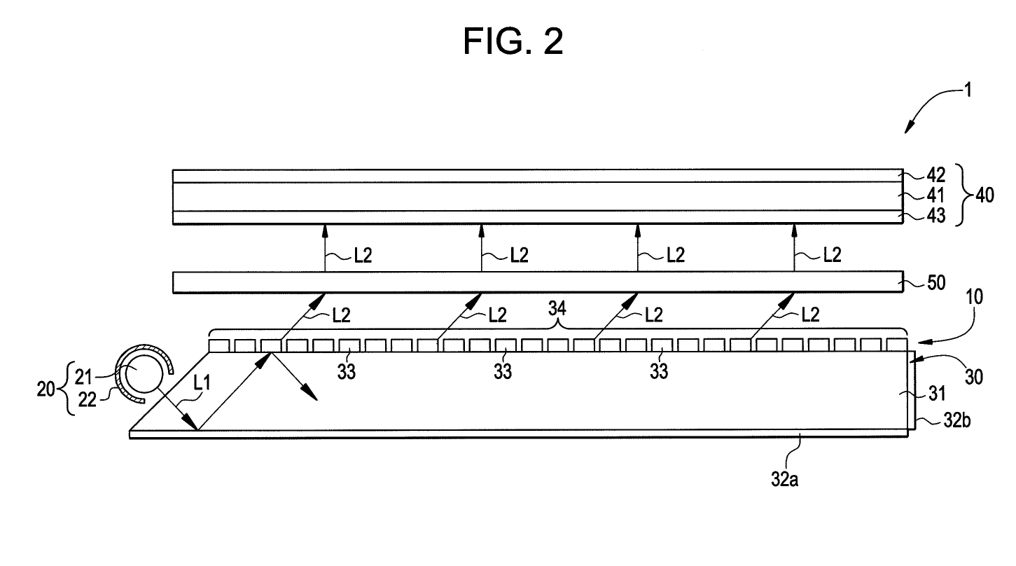

Furthermore, it is preferable for the metal grating 34 to be formed so that the degree of polarization η in light L2 is approximately 70% or higher. The degree of polarization η=100×(I2_{P}−I2_{S})/(I2_{P}+I2_{S}). In the case where the degree of polarization η is in the above described range, the P-polarized component is more dominant in light L2, and there is little of the S-polarized component which is cut by the polarizing plate usually provided on the input surface of the liquid crystal display panel in liquid crystal display apparatuses (for example, see polarizing plate 40 in FIG. 2), and therefore, light L2 can be effectively used.

The above described preferable configuration for the metal grating 34 can be implemented by adjusting the spatial period Λ and the thickness t in such a range that the fill factor is 0.55 or higher and 0.85 or lower, preferably 0.65 or higher and 0.85 or lower. In addition, it is preferable for the spatial period Λ to be lesser or equal to 57% of the wavelength λ of the above described light L1, and furthermore, it is preferable for the thickness to be adjusted to 400 nm or less. The spatial period Λ and the thickness t of the metal grating 34 can be selected by carrying out simulation, for example.

Furthermore, in the configuration of the light guiding plate 30 and the surface light source apparatus 10, the light source unit 20 has a reflecting member 22 and the input surface 31a is inclined relative to the emission surface 31b and the rear surface 31c, and thus, reduction in loss of light in the metal grating 34 can be achieved.

In the case where the rear surface 31c and the emission surface 31b are perpendicular to the input surface 31a, for example, light L1 that enters through the input surface 31a easily enters the emission surface 31b at an angle which is greater than the critical angle as determined by the index of refraction between the light guiding plate 31 and air, and thus loss of light in the metal grating 34 becomes great.

In contrast, in the case where the input surface 31a is inclined relative to the rear surface 31c and light L1 enters toward the rear surface 31c, the angle θ at which light L1 enters the emission surface 31b tends to be smaller than the critical angle. As a result, loss of light is reduced and the utilization efficiency of light L1 increases. In order to increase the utilization efficiency of light L1 as described above, the angle of inclination a of the input surface 31a relative to the rear surface 31c can be set to approximately 0° or greater and approximately 30° or smaller, as described above, and approximately 20° is an example.

In addition, the light source unit 20 has a reflecting member 22 and the portion of the reflecting member 22 which faces the input surface 31a has an opening, and therefore, light L1 that is emitted from the light source 21 effectively enters toward the rear surface 31a, and therefore, the incidence angle θ can be made further smaller. In order for light L1 that is emitted from the light source 21 to enter the light guiding plate 31 toward the rear surface 31c side, it is preferable for the reflecting member 22 to cover at least the upper side of the light source 21, as shown in FIG. 1, in the configuration shown in FIG. 1.

Furthermore, when the light guiding plate unit 30 and the surface light source apparatus 10 are formed so that light L1 that is emitted from the light source unit 20 is directed to the rear surface 31c side as described above, it becomes easier to make it so that light enters at the above described angle θ.

In addition, when reflecting member 22 is used, light L1 that is emitted from the light source 21 effectively enters the light guiding plate 30, and therefore, the utilization efficiency of light L1 from the light source 21 can further be increased.

As described above, in the light guiding plate unit 30 and the surface light source apparatus 10, when a metal grating 34 is provided on the emission surface 31b, it becomes possible for uniform light L2 of the P-polarized component to be emitted from almost the entire emission surface 31b, and at the same time, light L1 emitted from the light source 21 can be effectively used. Therefore, it is possible to achieve reduction in the thickness and weight of the liquid crystal display apparatus which includes the light guiding plate unit 30 and the surface light source apparatus 10 which incorporates the light guiding plate unit 30 as a backlight. This point is more specifically described below in reference to FIG. 2.

FIG. 2 is a schematic side view of the configuration of the liquid crystal display apparatus according to one embodiment of the present invention. The liquid crystal display apparatus 1 is appropriate for use in mobile phones and laptop personal computers, and the surface light source apparatus 10 shown in FIG. 1 is provided on the rear surface of the liquid crystal display unit 40 (lower side in FIG. 2) in the configuration. The liquid crystal display unit 40 is formed of polarizing plates 42 and 43 which are provided on both top and bottom surfaces, of a liquid crystal display panel 41. Well-known liquid crystal cells, such as that of a TFT type or an STN type, can be exemplified as the liquid crystal display panel 41.

As shown in FIG. 2, the purpose of the prism sheet 50 is to diffuse the light L2 that emits from the surface light source apparatus 10 in the direction of the normal to the emission surface 31b and to increase the uniformity of light that enters the liquid crystal display unit 40 placed on the other side of the prism sheet 50. The prism sheet 50 which is placed between the surface light source apparatus 10 and the liquid crystal display unit 40 is a slab of the same transparent material as that of the light guiding plate 30, and a commonly available prism sheet may be used, where plurality of prisms are formed either on the upper surface or on the lower surface of the prism sheet 50 so as to diffuse the light L2 emitted from the surface light source apparatus 10 in the direction of the normal to the emission surface 31b. Herein, FIG. 2 schematically shows the prism sheet 50. In this description, the prism sheet 50 is provided as shown in FIG. 2.

In the configuration of the liquid crystal display apparatus 1 shown in FIG. 2, when light L1 is emitted from the light source 21 in the surface light source apparatus 10, approximately uniform light L2 of the P-polarized component is emitted from approximately the entirety of the emission surface 31b, as described above. The direction in which light L2 is emitted from this surface light source apparatus 10 becomes uniform about the normal to the emission surface 31b after passing through the prism sheet 50, and after that light L2 enters the liquid crystal display portion 40.

Usually light in an unpolarized state is emitted from the surface light source apparatus placed on the rear surface of conventional liquid crystal display units (lower side in FIG. 2). In addition, a predetermined polarized component is selected by the polarizing plate on the lower side of the liquid crystal display unit to enter the liquid crystal display panel. The polarizing plate 43 usually absorbs the unused polarized component which does not transmit through the polarizing plate 43, and therefore, utilization efficiency of light is reduced. Therefore, as is evident, an additional optical element for recycling light from the surface light source apparatus (for example, polarization converters such as, quarter wavelength plate) is provided, and in this case, it is difficult to reduce the thickness and the size of the liquid crystal display apparatus.

In contrast, in the light guiding plate unit 30 and the surface light source apparatus 10 which includes the light guiding plate unit 30 in the present embodiment, a metal grating 34 is provided on the emission surface 31b as described above, and thus, part of the P-polarized component in light L1 that enters the light guiding plate 31 is emitted from the emission surface 31b side, and at the same time, light L1 that is not emitted is reflected into the light guiding plate 31.

Light L1 that is reflected back into the light guiding plate 31 propagates through the light guiding plate 31 while being repeatedly reflected between the rear surface 31c and the emission surface 31a, and in the mean time, light L1 becomes unpolarized inside the light guiding plate, and therefore, light L1 in unpolarized state reaches approximately every point of the emission surface 31b. As a result, recycling of light L1 that enters the light guiding plate unit 30 via the input surface 31a is made possible while P-polarized light L2 is emitted from approximately every point of the emission surface 31b.

Therefore, it is not necessary to provide a polarizer separately from the polarizing plate 43 in the liquid crystal display apparatus 1 in order to reuse an unnecessary polarized component, unlike in the prior art. Accordingly, it is possible to reduce the number of optical elements in the liquid crystal display apparatus 1, and therefore, reduction in the thickness and the weight of the liquid crystal display apparatus 1 can be achieved. Furthermore, the metal grating 34 is provided on the emission surface 31b of the light guiding plate 31 so that the degree of integration of the optical elements can be increased, and thus, further reduction in the thickness and weight of the liquid crystal display apparatus 1 is made possible. Moreover, it is possible to emit uniform light L2 from the light guiding plate unit 30, and therefore, image unevenness can be prevented on the liquid crystal display unit 40.

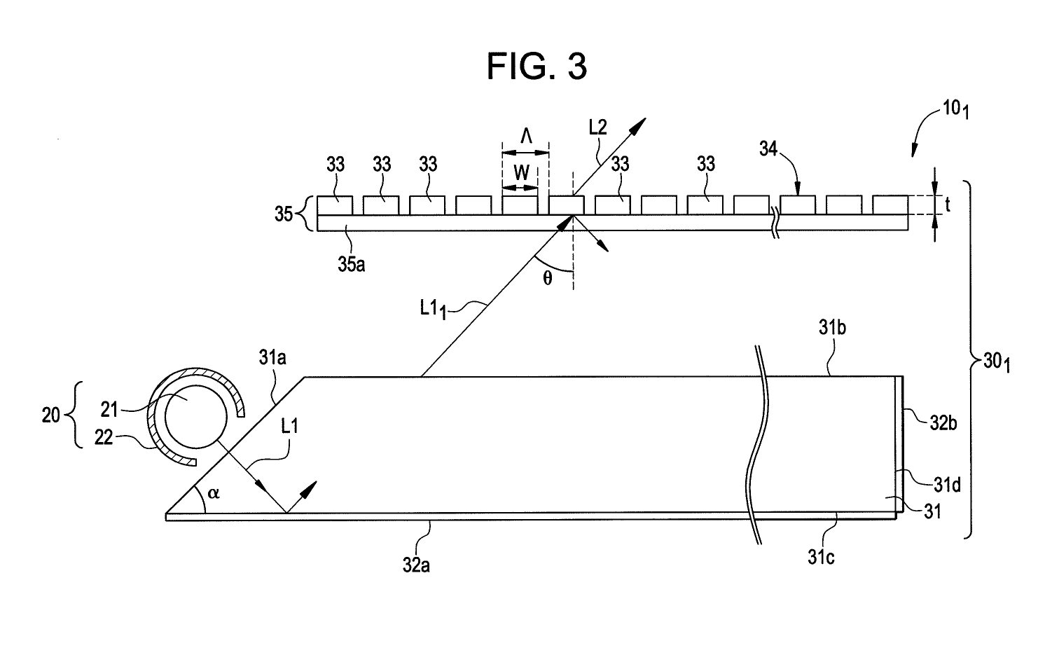

FIG. 3 is a schematic side view of the surface light source apparatus according to another embodiment of the present invention.

The surface light source apparatus 10₁ is formed so as to include a light source unit 20 and a light guiding plate unit 30₁. The configuration of the light source unit 20 is the same as in the case of the surface light source apparatus 10. The light guiding plate unit 30₁ is different from the light guiding plate unit 30 shown in FIG. 1 mainly in that it is provided with a diffraction grating element 35 in front of the emission surface 31b of the light guiding plate 31. This difference is the focus of the description below.

The diffraction grating element 35 includes a metal grating 34. The diffraction grating element 35 can have alight transmitting member 35a in the form of a slab for supporting the metal grating 34. The light transmitting member 35a is not particularly limited, as long as it is formed of a dielectric material which is essentially transparent to light emitted from the emission surface 31b of the light guiding plate 31.

In the case where the diffraction grating element 35 has a light transmitting member 35a, the configuration of the metal grating 34 is the same as in the case of the light guiding plate unit 30 shown in FIG. 1. Therefore, the configuration of the metal grating 34 in the case where the diffraction grating element 35 does not have a light transmitting member 35a is more specifically described herein.

In this case, the metal grating 34 is placed in the air. The fill factor of the metal grating 34 may be 0.65 or higher and 0.85 or lower. In addition, it is preferable for the spatial period Λ to be approximately 40% or less of the wavelength of light that enters the metal grating 34, so that the metal grating 34 functions as a diffraction grating of the 0 order. The spatial period Λ may be approximately 190 nm or less for blue light (light having a wavelength in the vicinity of 475 nm), for example, and approximately 256 nm or less for red light (light having a wavelength in the vicinity of 640 nm). In addition, it may be approximately 280 nm or less for light having a wavelength in the vicinity of 700 nm.

In the light guiding plate unit 30₁, light L1 that is emitted from the light source unit 20 enters the light guiding plate 31 through the input surface 31a so as to be guided through the light guiding plate 31. In addition, light which does not meet the conditions for total reflection at the emission surface 31b in light L1 is emitted from the emission surface 31b so as to enter the metal grating 34 in the diffraction grating unit 35. Herein, light emitted from the emission surface 31b in the light guiding plate unit 30₁ is referred to as light L1₁.

The metal grating 34 transmits part of the P-polarized component in light L1₁ that reaches the grating and reflects other components, and therefore, light L2 where the P-polarized component is dominant can be emitted from the light guiding plate unit 30₁. In addition, light that is diffracted by the metal grating 34 on the side of the light guiding plate 31, in other words, light that is reflected from the metal grating 34 reenters the light guiding plate 31 through the emission surface 31b side. This light that reenters includes more of the S-polarized component than of the P-polarized component, and returns to an unpolarized state when reflected from the diffusing and reflecting film 32a or the diffusing and reflecting film 32b, and therefore, it is possible to reuse light that returns to the light guiding plate 31 effectively.

In addition, the fill factor of the metal grating 34 is not set so that the transmittance of one polarized component becomes maximum, but rather the transmittance of one polarized component (here, the P-polarized component) is controlled, and therefore, it is possible for uniform light L2 to be emitted from the metal grating.

Accordingly, uniform light L2 where the P-polarized component is dominant can be emitted from the surface light source apparatus 10₁ having the light guiding plate unit 30₁. In addition, it is possible to use this surface light source apparatus 10₁ in place of the surface light source apparatus 10 in the liquid crystal display apparatus 1 shown in FIG. 2.

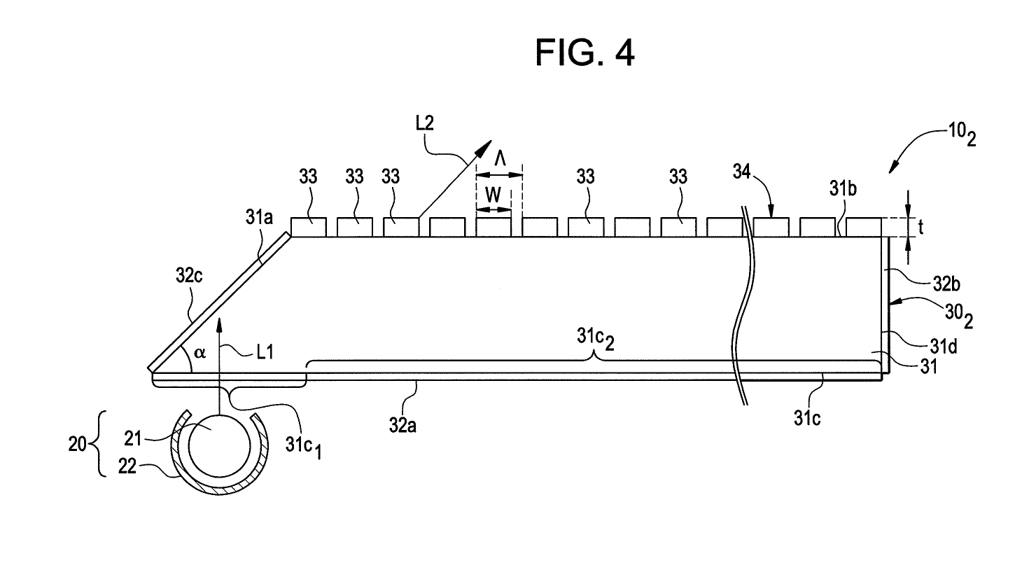

FIG. 4 is a schematic of the side view of the configuration of the surface light source apparatus according to still another embodiment of the present invention.

The surface light source apparatus 10₂ is different from the surface light source apparatus 10 shown in FIG. 1 in the configuration, mainly in that the light source unit 20 is provided on the rear surface 31c side of the light guiding plate unit 10₂.

The light guiding plate unit 30₂ is formed so as to include a light guiding plate 31 and a metal grating 34 which is provided on the emission surface 31b of the light guiding plate 31. A diffusing and reflecting film 32c is provided on the side 31a of the light guiding plate 31 and the rear surface 31c has a first region 31c₁ and a second region 31c₂ in this order starting from the side 31a, and a diffusing and reflecting film 32a is formed in the second region 31c₂. The diffusing and reflecting film 32c can be formed on the side 31d in the same manner as in the case of the light guiding plate unit 30. The first region 31c₁, where the diffusing and reflecting film 32a is not provided on the rear surface 31c, becomes an entrance region through which light L1 from the light source portion 20 enters. It is preferable for this first region 31c₁ to be directly beneath the side 31a in the case where the side 31a is inclined relative to the rear surface 31c as shown in FIG. 4. Herein, a case where the side 31a is inclined relative to the rear surface 31c is described.

The light source unit 20 is placed beneath the first region 31c₁ on the rear surface 31c. The light source unit 20 is formed so as to include a light source 21. The light source 21 is not particularly limited, as long as it can emit light L1 that includes visible light, and the light source 21 in the light guiding plate unit 10₂ may be an LED. It is preferable that a reflecting member 22 be provided around the light source 21 in the same manner as in the case of the surface light source apparatus 10.

In the surface light source apparatus 10₂ having the above described configuration, light L1 emitted from the light source unit 20 enters the light guiding plate 31 through the first region 31c₁ on the rear surface 31c. Light L1 that enters the light guiding plate 31 is reflected from the diffusing and reflecting film 32c provided on the side 31a and guided through the light guiding plate 31. In addition, part of the P-polarized component is emitted through the metal grating 34 as light L2 while propagating through the light guiding plate 31, as in the case of the light guiding plate unit 30. In addition, light that returns into the light guiding plate 31 through diffraction in the metal grating 34 is converted into unpolarized light by the diffusing and reflecting films 32a, 32b and 32c, and thus reused.

The configuration of the metal grating 34 is the same as it is in the configuration of the light guiding plate unit 30 shown in FIG. 1 and in the configuration of the surface light source apparatus 10 in which it is included, and therefore, the light guiding plate unit 31₂ and the surface light source apparatus 10₂ have the same working effects as the light guiding plate unit 30 and the surface light source apparatus 10 in which it is included. In addition, the surface light source apparatus 10₂ which includes the light guiding plate unit 31₂ can be used in place of the surface light source apparatus 10 in the liquid crystal display apparatus 1 shown in FIG. 2. Herein, though FIG. 4 shows a case where the metal grating 34 is formed directly on the emission surface 31b, it is possible to provide the metal grating 34 at a distance from the emission surface 31b, as in the case of the light guiding plate unit 30₂ shown in FIG. 3.

Though the side 31a is inclined relative to the rear surface 31c in the light guiding plate unit 30₂ in the above description, it is not necessary for the side 31a to be inclined relative to the rear surface 31c. In this case, the direction of the light source unit 20 or the location of the opening in the reflecting member 22 in the case where the light source unit 20 has a reflecting member 22 may be adjusted so that light L1 emitted from the light source unit 20 propagates toward the side 31a, for example.

Next, the mechanism to control the percentage transmission of the light L1 which is incident on the metal grating 34 by adjusting the fill factor of the metal gating 34 to a value within a predetermined range is concretely described on the basis of the results of simulation.

First, simulations carried out under the five conditions shown in Table 1 with the metal grating 34 placed in air is described. The case where the metal grating 34 is placed in air corresponds to the case where the diffraction grating unit 35 does not have a light transmitting member 35a in the configuration shown in FIG. 3. The conditions 1 to 3 are cases where the fill factor is in a predetermined range of 0.65 or higher and 0.85 or lower, and the condition 4 is a case where the fill factor is 0.5. The thickness t in Table 1 is the length of the metal fine wires 33 in the direction of the normal to the plane of the metal grating 34, and corresponds to the height of the trenches in the metal grating 34.

TABLE 1

| | | Spatial | Thickness t |
|---|---|---|---|
| | Fill factor | period Λ (nm) | (nm) |
| Condition 1 | 0.7 | 150 | 263.5 |
| Condition 2 | 0.8 | 120 | 95 |
| Condition 3 | 0.8 | 263.5 | 95 |
| Condition 4 | 0.5 | 170 | 95 |

A finite difference time domain (FDTD) method was adopted as the simulation technique. The wavelength of light L1 that is incident on the metal grating 34 was 527 nm, and the simulation was carried out for the respective cases where light L1 was P-polarized and S-polarized. In the simulations, light L1 emitted from the light source 21 entered through the light guiding plate 31 through the inclined input surface 31a. In addition, light L1 that entered through the entrance surface 31b at an angle smaller than the critical angle was emitted as light L1₁ so as to enter the metal grating 34. In the simulations, the angle θ at which light L1 is incident on the metal grating 34 (see FIG. 1) was changed by 10° at a time, so that the angular spectrum was obtained. Furthermore, in the simulations, the material for the light guiding plate 31 was PMMA having an index of refraction of 1.490. In addition, silver was adopted as the material for the metal fine wires 33, and the real and imaginary parts of complex index of refraction of silver was 0.051 and 3.366 respectively.

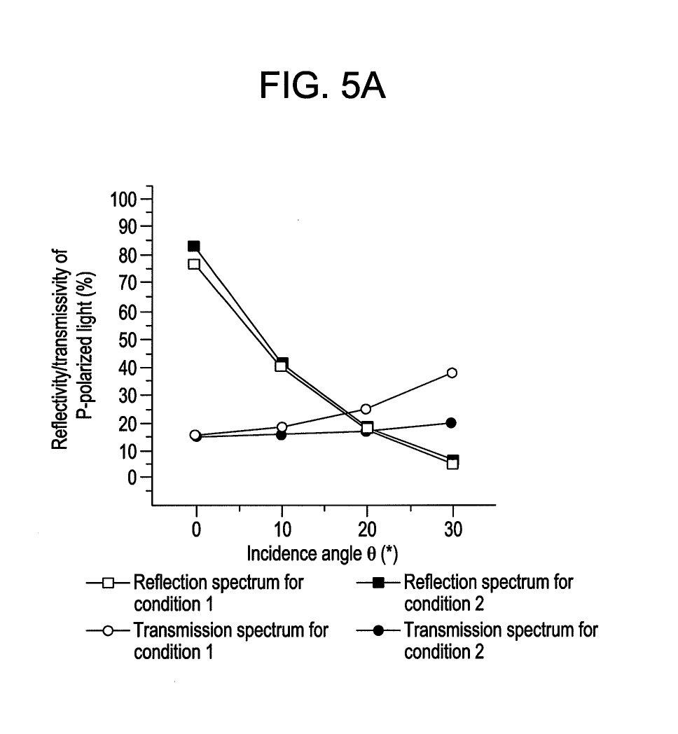

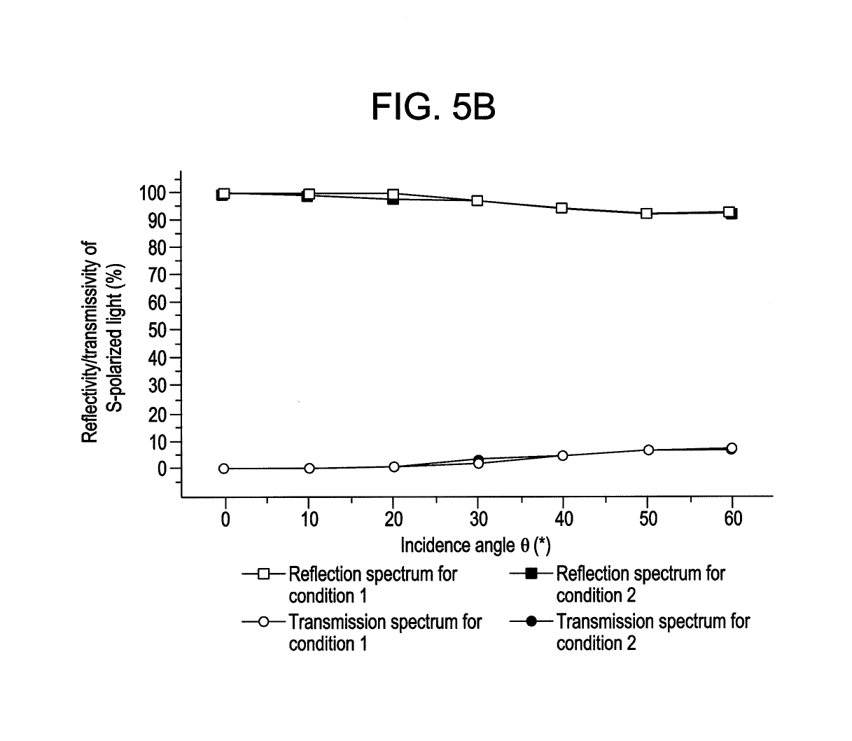

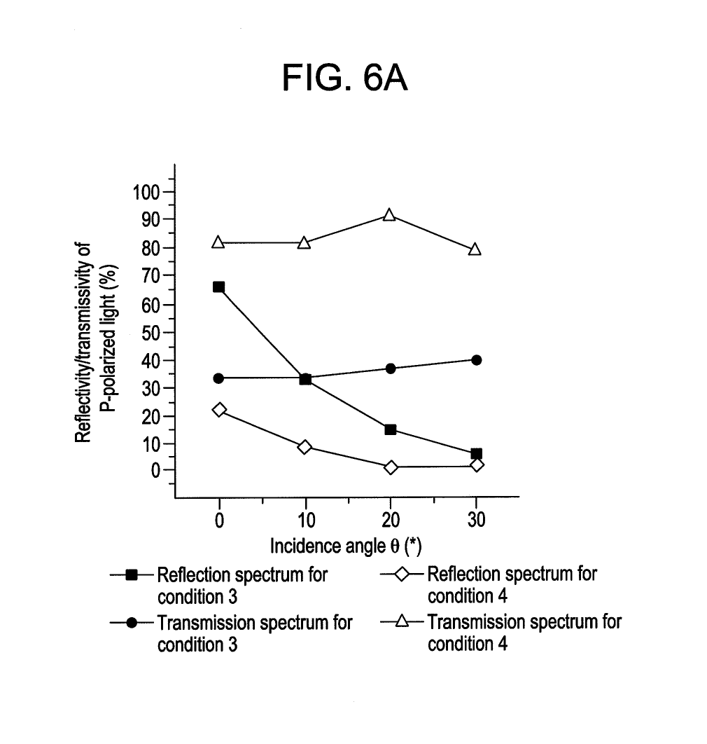

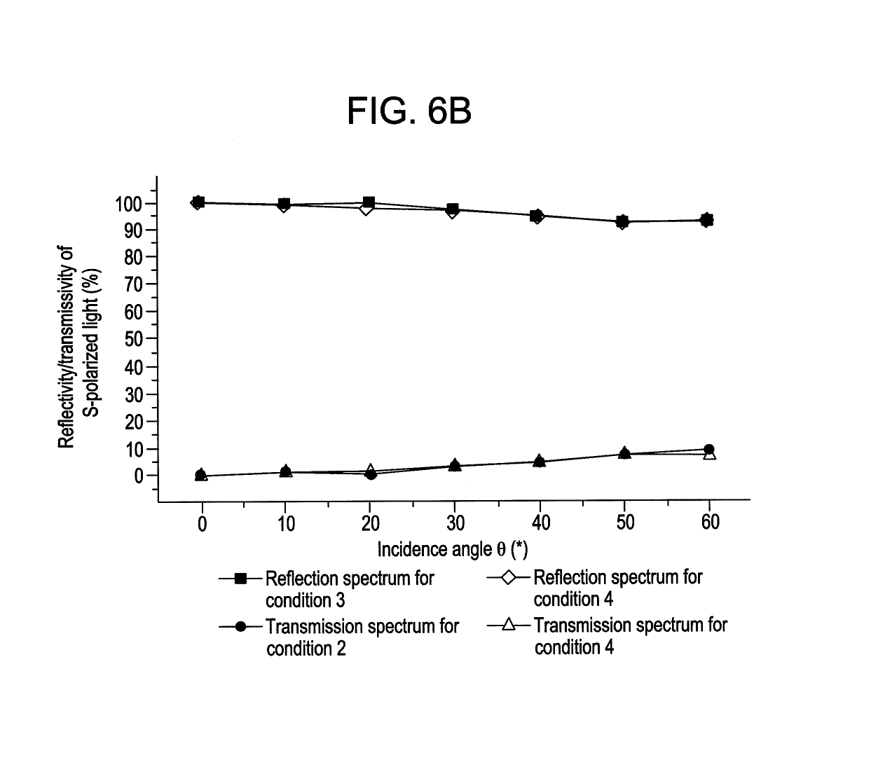

FIGS. 5A and 5B are graphs showing the results of simulation in the case of conditions 1 and 2. FIG. 5A shows the transmission spectrum and reflection spectrum of P-polarized light, and FIG. 5B shows the transmission spectrum and reflection spectrum of S-polarized light In addition, FIGS. 6A and 6B are graphs showing the results of simulation in the case of conditions 3 and 4. FIG. 6A shows the transmission spectrum and reflection spectrum of P-polarized light, and FIG. 6B shows the transmission spectrum and reflection spectrum of S-polarized light. The horizontal axis in FIGS. 5A to 6B indicates the incidence angle θ, and the vertical axis indicates the reflectivity and the transmissivity.

When the transmission spectrum of P-polarized light in the case of the conditions 1 and 2 shown in FIG. 5A is compared with the transmission spectrum of P-polarized light in the case of the condition 4 shown in FIG. 6A, the amount of transmission of P-polarized light was low in the case of conditions 1 and 2, compared to the case of condition 4. Concretely, the transmissivity of P-polarized light could be controlled within a range of approximately 7% to approximately 30% when the incidence angle θ is 0° to 30° in the case of the conditions 1 and 2, and in particular, it could be controlled to approximately 7% to approximately 22% in the case of the condition 2. Herein, the condition 3 is a case where the spatial period Λ exceeds 40% of the wavelength of 527 nm. In the case of the condition 3, as shown in FIG. 6A, the amount of transmission of P-polarized light could still be controlled better than in the case of condition 4, similar to the cases of conditions 1 and 2. However, as shown in FIG. 6A, in the case of the condition 3, the results show that the transmissivity exceeded approximately 30% for all of the angles θ at which light is incident on the gratings

Furthermore, when the reflection spectra of P-polarized light in the case of the conditions 1 to 3 shown in FIGS. 5A and 6A are compared with the reflection spectrum of P-polarized light in the case of condition 4 shown in FIG. 6A, the reflectivity of P-polarized light is high in the case of conditions 1 to 3 in comparison with the case of condition 4, and in particular, it can be seen that in the case of conditions 1 and 2, approximately 75% to approximately 90% of P-polarized light was reflected when the incidence angle θ was approximately 0°, as shown in FIG. 5A, that is to say, light L1 entered the emission surface 31b approximately perpendicularly.

Furthermore, in the transmission spectrum of S-polarized light in the case of the conditions 1 to 4 shown in FIGS. 5B and 6B, the transmissivity of S-polarized light was as low as 0% to approximately 10% when the incidence angle θ at which light impinged on the grating varies between 0° to 60°, particularly as low as 0% to approximately 5% when the incidence angle θ was 0° to 30°. In addition, it can be seen that in the reflection spectrum of S-polarized light in the case of the conditions 1 to 4, approximately 90% or more was reflected when the angle θ at which light impinged on the grating was 0° to 60°.

As described above, in the case where the metal grating 34 was provided at a distance from the emission surface 31b, as shown in FIG. 3, and the medium surrounding the metal grating 34 was air, part of the P-polarized component in light L1 could be selectively emitted from the metal grating 34 by setting the fill factor to 0.65 or higher and 0.85 or lower, which is higher than in the prior art, as described in reference to FIGS. 5A to 6B, and thus, the amount of transmission of light could be controlled. In addition, it was possible to selectively reflect light of the S-polarized component, and therefore, the ratio of the P-polarized component to the S-polarized component was high, that is to say, it was possible to attain selective transmission of P-polarized light. Furthermore, the portion of incident light L1 which was not transmitted through the metal grating 34 was reflected from the metal grating 34, and therefore could be reused.

Next, the configuration shown in FIG. 1, that is to say, the results of simulation in the case where the metal grating 34 is formed directly on the emission surface 31b, is described. The simulations were carried out under the conditions 5 to 10 shown in Table 2. The conditions 5 to 9 correspond to cases where the fill factor is 0.55 or higher or 0.85 or lower, the spatial period Λ is 57% or less of the wavelength λ of light L1, and the thickness t is 400 nm or less. On the other hand, condition 10 corresponds to a case where the fill factor is outside the above-described range.

TABLE 2

| | | Spatial | | |
|---|---|---|---|---|
| | Fill | period Λ | Thickness | Wavelength |
| | factor | (nm) | t (nm) | λ (nm) |
| Condition 5 | 0.8 | 120 | 95 | 527 |
| Condition 6 | 0.7 | 150 | 263.5 | 527 |
| Condition 7 | 0.6 | 170 | 95 | 475 |
| Condition 8 | 0.6 | 170 | 95 | 527 |
| Condition 9 | 0.6 | 170 | 95 | 640 |
| Condition 10 | 0.5 | 170 | 95 | 527 |

The simulations were carried out for the configuration shown in FIG. 1, that is to say, a configuration where the metal grating 34 is provided directly on the emission surface 31b of the light guiding plate 31. Simulations used two-dimensional models, where single incidence of light L1 on the metal grating 34 is considered. An FDTD method was adopted as the simulation technique. As in the case of the conditions 1 to 4, and respective simulations were carried out separately for the cases where the light L1 incident on the metal grating 34 was P-polarized and S-polarized. In the simulations, the incidence angle θ of light L1 on the metal grating 34 (see FIG. 1) was changed by 10° at a time, in order to compute the angular spectrum. Furthermore, in the simulations, the material for the light guiding plate 31 was PMMA having an index of refraction of 1.490, and the medium on the side of the emission surface 31b opposite to the rear surface 31c was air having an index of refraction of 1.00. In addition, the material for the metal fine wires 33 was silver and the complex index of refraction of silver was adopted as the index of refraction of the metal fine wires 33.

Specifically, the real part and the imaginary part of the index of refraction were 0.051 and 3.366 for a wavelength of 527 nm, respectively, the real part and the imaginary part of the index of refraction were 0.049 and 2.927 for a wavelength of 475 nm, respectively, and the real part and the imaginary part of the index of refraction were 0.054 and 4.317 for a wavelength of 640 nm, respectively.

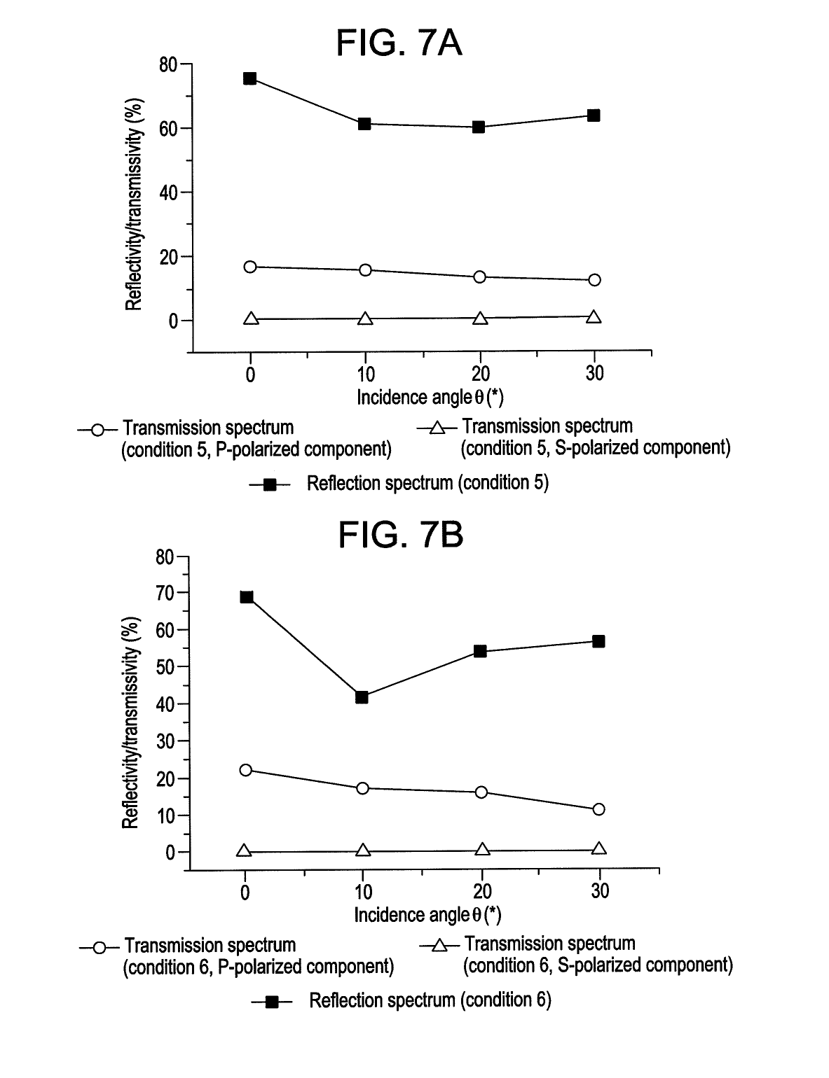

FIGS. 7A and 7B are graphs showing the results of simulation in the case of the conditions 5 and 6. FIG. 7A shows the results of simulation in the case of the condition 5, and FIG. 7B shows the results of simulation in the case of condition 6. More specifically, FIGS. 7A and 7B show transmission spectra where the transmissivity, which is the ratio of light L2 emitted from the light guiding plate 31 to light L1 that is incident on the metal grating 34, changes in accordance with the incidence angle θ and reflection spectra where the reflectivity, which is defined as the ratio of light that returns into the light guiding plate 31 to light L1 that is incident on the metal grating 34, changes in accordance with the incidence angle θ. In case of FIGS. 7A and 7B the reflectivity at each incidence angle θ represents the average value of two reflectivities, one is obtained when the incident light L1 was P-polarized and the other is obtained when the incident light L1 was S-polarized, respectively, and therefore, the reflectivity corresponds to the quotient of the sum of the intensity of P-polarized light and S-polarized light that was reflected by the sum of the intensity of P-polarized light and S-polarized light that is incident on the metal grating 34, shown in percentages. In FIGS. 7A and 7B, the incidence angle θ is plotted along the horizontal axis, and the transmissivities and reflectivities are plotted along the vertical axis.

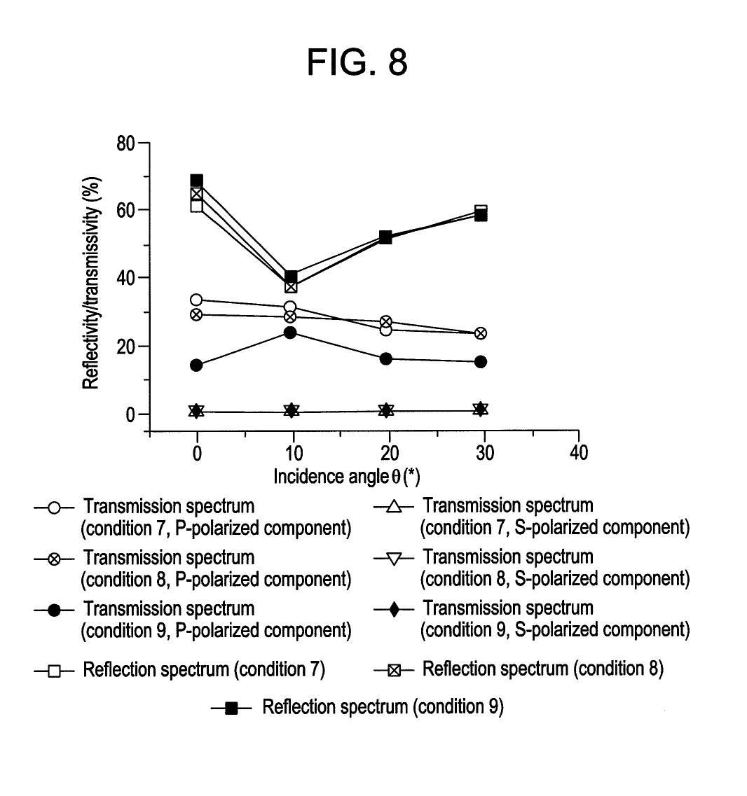

In addition, FIG. 8 is a diagram showing the results of simulation in case of the conditions 7 to 9. In FIG. 8, the horizontal axis indicates the incidence angle θ and the vertical axis indicates the transmissivity and the reflectivity. The transmission and the reflection spectra in the case of conditions 7 to 9 are shown, in the same manner as in FIGS. 7A and 7B.

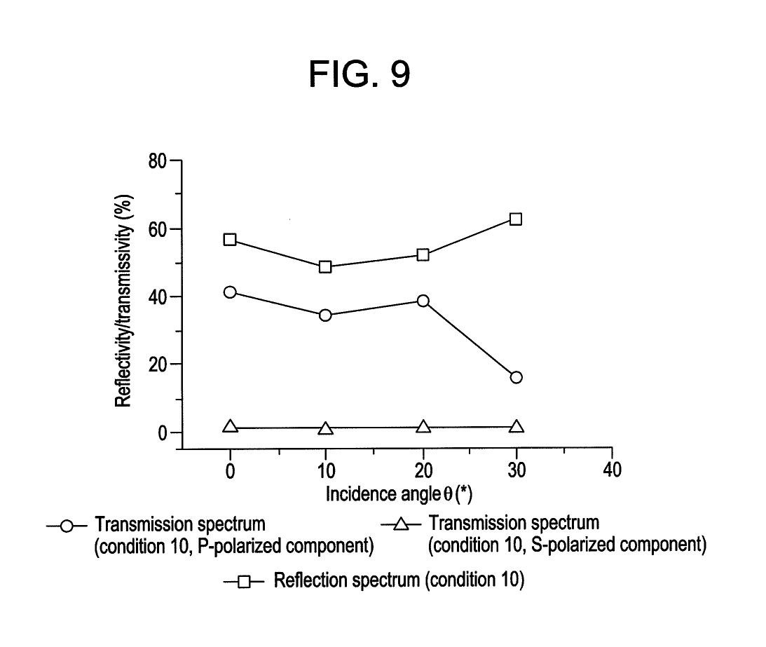

Furthermore, FIG. 9 is a graph showing the results of simulation in the case of condition 10. In FIG. 9, the incidence angle θ is plotted along the horizontal axis and the transmissivities and the reflectivities are plotted along the vertical axis. FIG. 9 shows the transmission spectra and the reflection spectrum in the case of the condition 10, as in the case of FIGS. 7A and 7B.

It can be seen from FIG. 7A that in the case of condition 5, the transmissivity of P-polarized light was in a range from approximately 10% to approximately 20% and the transmittance of S-polarized light changed in the vicinity of approximately 0% when the incidence angle θ was in a range from 0° to 30°. In addition, it can be seen that the reflectivity was in the range from approximately 60% to approximately 80% when the incidence angle θ of light L1 impinging on the grating was 0° to 30°, and approximately 80% for normal incidence. In addition, as shown in FIG. 7B that in the case of condition 6, the transmissivity of P-polarized light was in a range from approximately 15% to approximately 25% and the transmissivity of S-polarized component changed within a range of approximately 0% to approximately 5%. In addition, the reflectivity was in a range from approximately 40% to approximately 70% when the incidence angle θ was 0° to 30° and as high as approximately 70% when light is incident normally.

In addition, as shown in FIG. 8, in the case of conditions 7 to 9, the transmissivity of P-polarized light was approximately 7% to approximately 35% and the transmissivity of S-polarized light was approximately 0%. Further, the reflectivity was as high as approximately 40% to approximately 70% and approximately 60% or higher when light is incident normally. In addition, when the wavelength λ was 527 nm (green light) and 640 nm (red light), which are longer than 500 nm, the tranamissivity of P-polarized light was approximately 30% or lower, and when the wavelength λ was 475 nm (blue light), which is shorter than 500 nm, the transmissivity of F-polarized light was approximately 35% or lower. Thus, in the case of conditions 7 to 9, where the fill factor was 0.6, it was possible to control the transmissivity of P-polarized light and the transmissivity of S-polarized light to a desired value using the metal grating 34 provided on the emission surface 31b of the light guiding plate 31, and as a result, it was possible to obtain a transmission L2 which is rich in P-polarized light from approximately the whole of the emission surface 31b.

On the other hand, as shown in FIG. 9, in the case of the condition 10, the transmissivity of S-polarized light was approximately 0% when the incidence angle θ was 0° to 30°, the transmissivity of P-polarized light was approximately 20% when the incidence angle θ was 30°, and the transmittance of P-polarized light was approximately 40% when the incidence angle θ was in a range from 0° to 20°. In addition, the reflectivity was approximately 50% to approximately 70% when the incidence angle θ was 0° to 30° and approximately 60% for normal incidence. Thus, the transmissivity of P-polarized light was high and the reflectance low in the configuration where the fill factor was 0.5 in the case of the condition 10, in comparison with the case of the conditions 5 to 8. Therefore, it became difficult to extract uniform light L2 from approximately the whole of the emission surface 31b, in comparison with the case of the conditions 5 to 9, for example.

As described on the basis of the results of simulation shown in FIGS. 7A to 9, in the case where the fill factor was 0.5, the transmissivity of the P-polarized component tended to be higher, and it became possible to adjust the transmittance of the P-polarized component within a desired range by adopting a configuration where the fill factor was 0.55 or higher and 0.85 or lower in the conditions 5 to 9. As a result, it became possible to extract uniform light L2 where the P-polarized component was dominant from approximately the entire emission surface 31b, and thus, the S-polarized component that is not transmitted could be reused effectively.

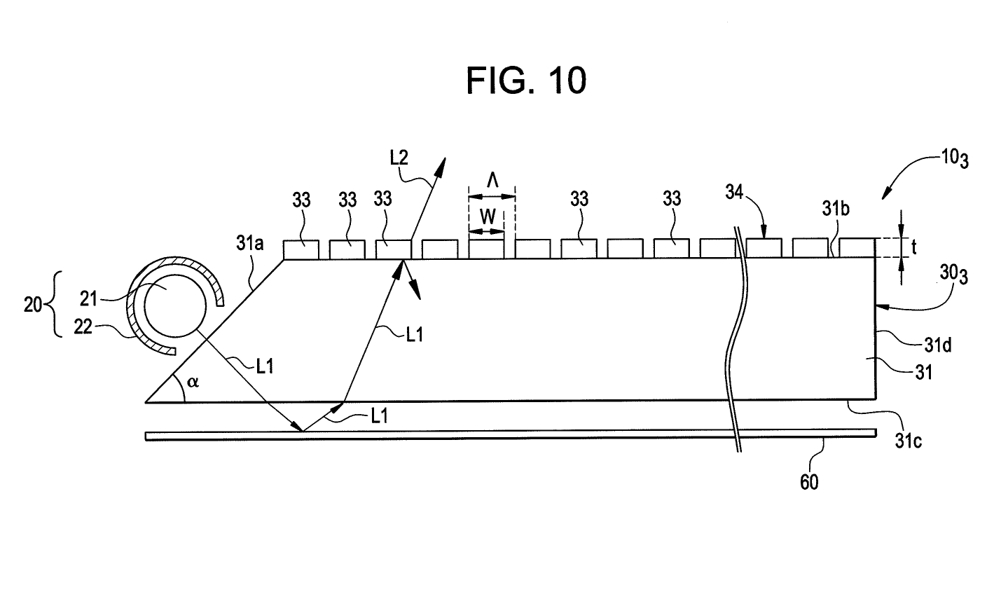

Though the embodiments of the present invention are described above, the present invention is not limited to these embodiments. For example, though a diffusing and reflecting film 32a is provided on the rear surface 31c of the light guiding plate unit 30 as a reflecting unit, it is not necessary to form a diffusing and reflecting film 32a on the rear surface 31c. For example, it is possible for the surface light source apparatus 10₃ to have a configuration where a diffusing and reflecting plate (reflecting unit) 60 for diffusing, and thus depolarizing, light L1 in the same manner as the diffusing and reflecting film 32a is provided beneath the rear surface 31c, as does the surface light source apparatus 10₃ shown in FIG. 10. In this case, light L1 which enters the side 31a and light L1 which is reflected from the metal grating 34 on the emission surface 31b side so as to be directed toward the rear surface 31c side is emitted from the rear surface 31c once, and after that reflected from the diffusing and reflecting plate 60 placed beneath the rear surface 31c, and then enters the light guiding plate 31 via the rear surface 31c and passes through the metal grating 34. Herein, though the configuration shown in FIG. 1 is cited as an example for description, the light guiding plate units 30₁ and 30₂ shown in FIGS. 3 and 4 and the surface light source apparatuses 10₁ and 10₂ which include these are the same. Furthermore, as the diffusing and reflecting films 32b and 32c, a reflecting unit which is provided at a distance from the side of the light guiding plate 31 where the films are provided can be adopted.

In addition, though the side 31a is inclined relative to the emission surface 31b and the rear surface 31c, the side 31a, for example, can be inclined relative to at least one of the rear surface 31c or the emission surface 31b, and it is also possible for it to be approximately perpendicular to either the rear surface 31c or the emission surface 31b. Further, though the emission surface 31b and the rear surface 31c are approximately parallel, the invention is not limited to this, and one of the emission surface 31b and the rear surface 31c, for example, may be inclined relative to the other.

In addition, though the light source 21 is provided on one side 31a of the light guiding plate 31 in the configuration shown in FIG. 1, for example, it is also possible to install light sources 21 on a number of sides of the light guiding plate 31. As shown in FIG. 1, another light source 21 may be installed in such a location as to face the side 31d, for example, without forming a diffusing and reflecting film 32b on the side 31d. In this case, the side 31d also functions as an input surface. Likewise, it is possible to provide a light source 21 beneath the rear surface 31c in the vicinity of another side of the light guiding plate 31 in the configuration shown in FIG. 4. Furthermore, though a reflecting member 22 is provided on the outside of the light source 21, it is possible not to provide a reflecting member 22. Herein, as described above, it is preferable to provide a reflecting member 22 in order to increase utilization efficiency of light. Furthermore, in the case where a light source unit 20 is provided on the side of the light guiding plate 31, as shown in FIG. 1, diffusing and reflecting films which are the same as the diffusing and reflecting film 32a can be formed on sides other than the side through which light L1 from the light source unit 20 enters. Furthermore, in the case where light L1 enters through part of the rear surface 31c of the light guiding plate 31, as shown in FIG. 4, it is possible to form diffusing and reflecting films which are the same as the diffusing and reflecting film 32a on all of the sides of the light guiding plate 31.

Further, though a polarizing plate 43 is provided on the lower surface side of the liquid crystal display panel 41 in the liquid crystal display apparatus 1 shown in FIG. 2, it is possible not to provide a polarizing plate 43 in the case where the transmissivity of the S-polarized component is close to approximately 0%, for example, considering the transmission properties of the metal grating 34.

Furthermore, it is preferable for the metal grating 34 to be formed so that the brightness of light L2 is uniform when the angle θ_{O} between light L2 that exits and the direction of the normal to the metal grating 34, in other words the direction of the normal to the emission surface 31b, is in a range from approximately 0° to approximately 30°. As a result, it is possible to display images possessing uniform brightness on the liquid crystal display unit 40 of the liquid crystal display apparatus 1 shown in FIG. 2.

In addition, though the light source 21 is a fluorescent light in the description so far unless otherwise stated, it may be light emitting diodes, as described above. In addition, it is possible to adopt light emitting diodes as the light source 21 when the spatial period Λ is defined for the wavelength λ of light L1.

Furthermore, though the metal grating 34 is provided directly on the emission surface 31b in the light guiding plate unit 30 and the surface light source apparatus 10 shown in FIG. 1, a dielectric layer may be provided on the emission surface 31b, and the metal grating 34 may be formed on this dielectric layer, for example. The dielectric layer may be formed of the same material as the light transmitting member 35a, and the index of refraction thereof may be the same or different from that of the light guiding plate 31. The dielectric layer might be, for example, a thin film coating.

Herein, though the light guiding plate unit includes a light guiding plate and a metal grating and the surface light source apparatus includes a light guiding plate unit and a light source unit in the description so far, the surface light source apparatus can be regarded as a light guiding plate apparatus which further includes a light source unit in the case where the light guiding plate unit is regarded as a light guiding plate apparatus. Further, in the case where the metal grating 34 is provided directly on the light guiding plate 31, as shown in FIG. 1, the light guiding plate 31 can be considered to be the main body of the light guiding plate where a metal grating (diffraction grating) is formed on the emission surface (first surface) of this main body of the light guiding plate, for example. In this case, the light guiding plate unit 30 can be regarded as one light guiding plate which includes the main body of the light guiding plate and a metal grating.

1. A light guiding plate unit, comprising:
a light guiding plate which can guide light and has a first surface through which light is emitted; and
a diffraction grating provided on the first surface of the light guiding plate, wherein
the diffraction grating is formed of a number of metal wires which are laid out in parallel straight lines, and
the length of the metal wires in the direction perpendicular to the long axis of the metal wires and parallel to the first surface is approximately 55% or more and approximately 85% or less of the spatial period of the diffraction grating.

2. The light guiding plate unit according to claim 1, characterized in that the length of the metal wires in the direction perpendicular to the long axis of the metal wires and parallel to the first surface is approximately 65% or more and approximately 85% or less of the spatial period.

3. The light guiding plate unit according to claim 1, wherein
a reflecting and diffusing unit is further provided on a second surface of the light guiding plate which faces the first surface, and
the reflecting and diffusing unit depolarizes light that is incident on the second surface and reflects the unpolarized light toward the light guiding plate side.

4. The light guiding plate unit according to claim 1, wherein the spatial period is approximately 57% or less of the wavelength of the light in the case where the diffraction grating is provided directly on the first surface.

5. The light guiding plate unit according to claim 1, wherein the spatial period is approximately 40% or less of the wavelength of the light in the case where the diffraction grating is provided at a distance from the first surface and a medium surrounding the diffraction grating is air.

6. The light guiding plate unit according to claim 1, wherein the transmissivity of the diffraction grating is approximately 7% or higher and approximately 30% or lower in the case where light having a wavelength which is longer than 500 nm impinges on the diffraction grating.

7. The light guiding plate unit according to claim 1, wherein the transmissivity of the diffraction grating is approximately 7% or higher and approximately 35% or lower in the case where light having a wavelength which is 500 nm or less impinges on the diffraction grating.

8. The light guiding plate unit according to claim 1, wherein the length of the metal wires in the direction of the normal to the diffraction grating is 400 nm or less.

9. The light guiding plate unit according to claim 1, wherein a cross-sectional shape of the metal wires which is approximately perpendicular to the long axis of the metal wires is square or rectangular.

10. The light guiding plate unit according to claim 1, wherein the degree of polarization in the light transmitted through the diffraction grating is approximately 70% or higher.

11. The light guiding plate unit according to claim 1, wherein the brightness of light that is transmitted through the diffraction grating is approximately uniform within an angular range of approximately 0° or higher and approximately 30° or lower relative to the direction of the normal to the diffraction grating.

12. The light guiding plate unit according to claim 1, wherein
the light guiding plate has:
a second surface which faces the first surface; and
a third surface which is located to the side of the first and second surfaces, wherein
the third surface is inclined relative to at least one of the first and second surfaces.

13. A surface light source apparatus, comprising: a light guiding plate which can guide light and has a first surface through which light is emitted;
a light source for outputting light which is guided by the light guiding plate; and
a diffraction grating provided on the first surface of the light guiding plate, wherein
the diffraction grating is formed of a number of metal wires which are laid out in parallel straight lines, and
the length of the metal wires in the direction perpendicular to the long axis of the metal wires and parallel to the first surface is approximately 55% or more and approximately 85% or less of the spatial period of the diffraction grating.

14. The surface light source apparatus according to claim 13, wherein the length of the metal wires in the direction perpendicular to the long axis of the metal wires and parallel to the first surface is approximately 65% or more and approximately 85% or less of the spatial period.

15. The surface light source apparatus according to claim 13, wherein
a reflecting and diffusing unit is further provided on a second surface of the light guiding plate which faces the first surface, and
the reflecting and diffusing unit is located on the second surface side, depolarizes light that propagates toward the second surface side and reflects the unpolarized light toward the light guiding plate side.

16. The surface light source apparatus according to claim 13, wherein the surface light source apparatus further comprises a reflecting member which is located on the outside of the light source and reflects light emitted from the light source toward the light guiding plate side.

17. The surface light source apparatus according to claim 13, wherein the spatial period of the arrangement of the metal wires is 57% or less of the wavelength of the light in the case where the diffraction grating is provided directly on the first surface.

18. The surface light source apparatus according to claim 13, characterized in that the spatial period is approximately 40% or less of the wavelength of the light in the case where the diffraction grating is provided at a distance from the first surface and the medium surrounding the diffraction grating is air.

19. The surface light source apparatus according to claim 13, wherein the transmissivity of the diffraction grating is approximately 7% or higher and approximately 30% or lower in the case where light having a wavelength which is longer than 500 rim impinges on the diffraction grating.

20. The surface light source apparatus according to claim 13, wherein the transmissivity of the diffraction grating is approximately 7% or higher and approximately 35% or lower in the case where light having a wavelength which is 500 nm or less impinges on into the diffraction grating.

21. The surface light source apparatus according to claim 13, wherein the length of the metal wires in the direction of the normal to the diffraction grating is 400 nm or less.

22. The surface light source apparatus according to claim 13, wherein the form of the cross-sectional shape of the metal wires which are approximately perpendicular to the long axis of the metal wires is square or rectangular.

23. The surface light source apparatus according to claim 13, wherein the degree of polarization of light that is transmitted through the diffraction grating is approximately 70% or higher.

24. The surface light source apparatus according to claim 13, wherein the brightness of light that is transmitted through the diffraction grating is approximately uniform within an angular range of approximately 0° or higher and approximately 30° or lower relative to the direction of the normal to the diffraction grating.

25. The surface light source apparatus according to claim 13, wherein
the light guiding plate has:
a second surface which faces the first surface; and
a third surface which is located on the side of the first and second surfaces, wherein p1 the third surface is inclined relative to at least one of the first and second surfaces.

26. The surface light source apparatus according to claim 25, wherein
the light source unit is positioned so as to face the third surface, and
the third surface is inclined relative to the second surface, and the inclination angle is greater than approximately 0° and approximately 30° or less in the case where light emitted from the light source unit impinges on the light guiding plate through the third surface.

27. A liquid crystal display apparatus, comprising: a surface light source apparatus; and
a liquid crystal display unit into which light emitted from the surface light source apparatus enters, wherein
the surface light source apparatus comprises:
a light guiding plate which can guide light and has a first surface through which light is emitted;
a light source for outputting light which is guided by the light guiding plate; and
a diffraction grating provided on the first surface of the light guiding plate, wherein
the diffraction grating is formed of a number of metal wires which are in parallel straight lines, and
the length of the metal wires in the direction perpendicular to the long axis of the metal wires and parallel to the first surface is approximately 55% or more and approximately 85% or less of the spatial period of the diffraction grating.

28. The liquid crystal display apparatus according to claim 27, wherein the length of the metal wires in the direction perpendicular to the long axis of the metal wires and parallel to the first surface is approximately 65% or more and approximately 85% or less of the spatial period.

29. The liquid crystal display apparatus according to claim 27, wherein
a reflecting and diffusing unit is further provided on the light guiding plate,
the light guiding plate has a second surface which faces the first surface, and
the reflecting and diffusing unit is located on the second surface side, depolarizes light that propagates toward the second surface side, and reflects the unpolarized light toward the light guiding plate side.

30. The liquid crystal display apparatus according to claim 27, wherein the liquid crystal display apparatus further comprises of a reflecting member which is located on the outside of the light source and reflects light emitted from the light source toward the light guiding plate side.
